(19) United States
(12) Patent Application Publication
(10) Pub. No.: US 2026/0169189 A1
(43) Pub. Date: Jun. 18, 2026

(54) META-OPTICAL DEVICE

(71) Applicant: INDUSTRIAL TECHNOLOGY RESEARCH INSTITUTE, HSINCHU (TW)

(72) Inventors: Hsueh-Chih CHANG, Changhua County (TW); Chy-Lin WANG, Hsinchu County (TW); Tai-Yuan YEH, Miaoli County (TW)

(21) Appl. No.: 18/983,376

(22) Filed: Dec. 17, 2024

(51) Int. Cl. G02B 1/00; F21V 5/04

(52) U.S. Cl. CPC G02B 1/002; F21V 5/04

(57) ABSTRACT

Embodiments of the present disclosure provide a meta-optical device including a light-emitting element having a light-emitting surface, a multifocal meta-lens above the light-emitting surface, and a light-receiving element on a side of the multifocal meta-lens opposite to the light-emitting element. The multifocal meta-lens is distanced from the light-emitting surface by a distance (d) in a direction perpendicular to the light-emitting surface. The multifocal meta-lens has a plurality of focus regions projected onto the light-emitting surface, where a diameter (φ) of each of the focus regions on the light-emitting surface, the distance (d), and an acceptance angle (θ) of the light-receiving element meet: φ≤(2×d×tan(θ)).

### BACKGROUND

### Field of Invention

The present disclosure relates to an optical device. More particularly, the present disclosure relates to the optical device having the meta-optics.

### Description of Related Art

An optical device for illumination or display includes a light source and a light-receiving element. A light source with wide divergence angle, such as a light-emitting diode, is usually applied to increase the brightness and the uniformity of the optical device. However, as the light source has larger divergence angle, it becomes more difficult to couple the light beam from the light source to light-receiving element. This may reduce the coupling efficiency of the optical device or increase the crosstalk risk of the light beams.

### SUMMARY

According to some embodiments of the present disclosure, a meta-optical device includes a light-emitting element having a light-emitting surface, a multifocal meta-lens above the light-emitting surface, and a light-receiving element on a side of the multifocal meta-lens opposite to the light-emitting element. The multifocal meta-lens is distanced from the light-emitting surface by a distance (d) in a direction perpendicular to light-emitting surface. The multifocal meta-lens has a plurality of focus regions projected onto the light-emitting surface. A diameter (φ) of each of the focus regions on the light-emitting surface, the distance (d), and an acceptance angle (θ) of the light-receiving element meet:

$$ϕ \leq ( 2 \times d \times tan ( θ ) ) .$$

According to some embodiments of the present disclosure, a meta-optical device includes a light-emitting element array, a plurality of multifocal meta-lenses above the light-emitting element array, a meta-lens above the multifocal meta-lenses, and at least one light-receiving element on a side of the meta-lens opposite to the multifocal meta-lenses. The light-emitting element array includes a plurality of light-emitting elements adjacently arranged, where each of the light-emitting elements has a light-emitting surface. The multifocal meta-lenses are distanced from the light-emitting elements by a distance (d). Each of the multifocal meta-lenses has a plurality of focus regions projected onto the light-emitting surface of a corresponding one of the light-emitting elements, respectively. A diameter (φ) of each of the focus regions, the distance (d), and an acceptance angle (θ) of the light-receiving element meet: φ≤(2×d×tan(θ)).

According to the above-mentioned embodiments, the meta-optical device of the present disclosure includes a multifocal meta-lens between the light-emitting element and the light-receiving element, were the multifocal meta-lens has focus regions projected onto the light-emitting surface of the light-emitting element. These focus regions having appropriate dimensions may increase a ratio between the luminous flux received by the light-receiving element and the luminous flux emitted by the light-emitting element, thereby increasing the coupling efficiency of the meta-optical device.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a schematic side view of a meta-optical device, according to some embodiments of the present disclosure.

FIG. 2 illustrates the light paths of the meta-optical device, according to some embodiments of the present disclosure.

FIG. 3 illustrates the light paths of the optical device without the multifocal meta-lens.

FIG. 4 illustrates a schematic side view of a meta-optical device, according to some embodiments of the present disclosure.

FIGS. 5A-5C, FIGS. 6A-6C, FIGS. 7A-7C, and FIGS. 8A-8C illustrate focus region distributions, collimating focal point distributions, and nanostructure phase distributions, according to some embodiments of the present disclosure.

FIG. 9A illustrates a cross-section schematic view of a multifocal meta-lens, according to some embodiments of the present disclosure.

FIGS. 9B-9G illustrate partial cross-section schematic views of multifocal meta-lenses, according to some embodiments of the present disclosure.

FIG. 10-13 illustrate schematic side views of meta-optical devices, according to some embodiments of the present disclosure.

### DETAILED DESCRIPTION

The following disclosure provides many different embodiments, or examples, for implementing different features of the provided subject matter. Specific examples of components, arrangements, etc., are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments of the present disclosure provide a meta-optical device including a multifocal meta-lens between a light-emitting element and a light-receiving element. The multifocal meta-lens has multiple focus regions projected onto one light-emitting surface of the light-emitting element. The diameter of these focus regions, the distance between the multifocal meta-lens and the light-emitting surface, and the acceptance angle of the light-receiving element meet specific formulas, which may increase a ratio between the luminous flux received by the light-receiving element and the luminous flux emitted by the light-emitting element, thereby increasing the coupling efficiency of the meta-optical device.

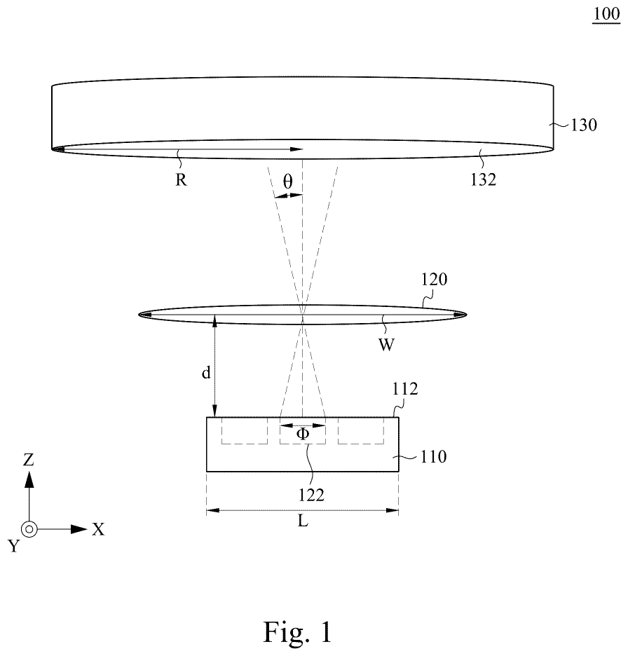

According to some embodiments of the present disclosure, FIG. 1 illustrates a schematic side view of a meta-optical device 100 in X-Z plane. The meta-optical device 100 includes a light-emitting element 110 having a light-emitting surface 112, a multifocal meta-lens 120 above the light-emitting surface 112, and a light-receiving element 130 on a side of the multifocal meta-lens 120 opposite to light-emitting element 110. In other words, the multifocal meta-lens 120 is positioned between the light-emitting element 110 and the light-receiving element 130, so that the light beam emitted by the light-emitting surface 112 passes through the multifocal meta-lens 120 before reaching the light incident surface 132 of the light-receiving element 130.

Specifically, the light-emitting surface 112 of the light-emitting element 110 emits the light beams toward various directions. The multifocal meta-lens 120 may reduce the divergence angle of the light beams, so that the light beam may be collimated to narrow down the traveling region of the light beams and increase the luminous flux received by the light-receiving element 130. In some embodiments, the light-emitting element 110 may have a large divergence angle to act as a wide angle light source. For example, the light-emitting element 110 may be a single light-emitting diode (LED) chip, a micro light-emitting diode (micro LED) chip, an area light source including a light-emitting chip and a light guide plate, or combinations thereof.

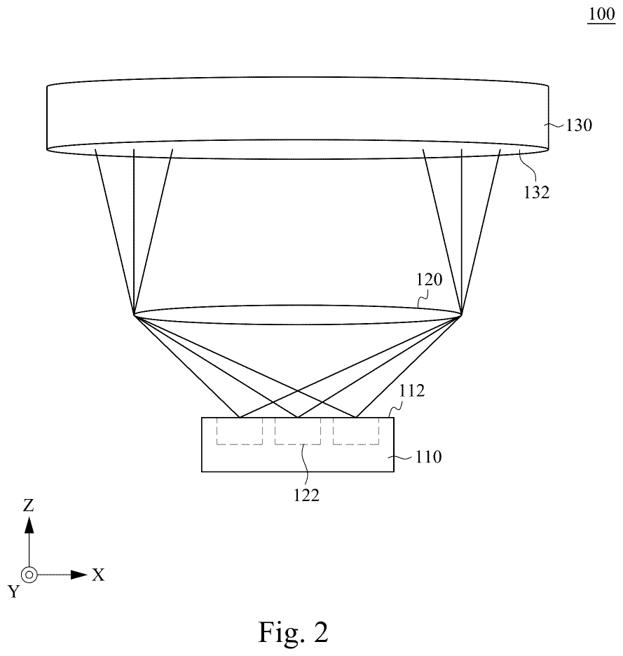

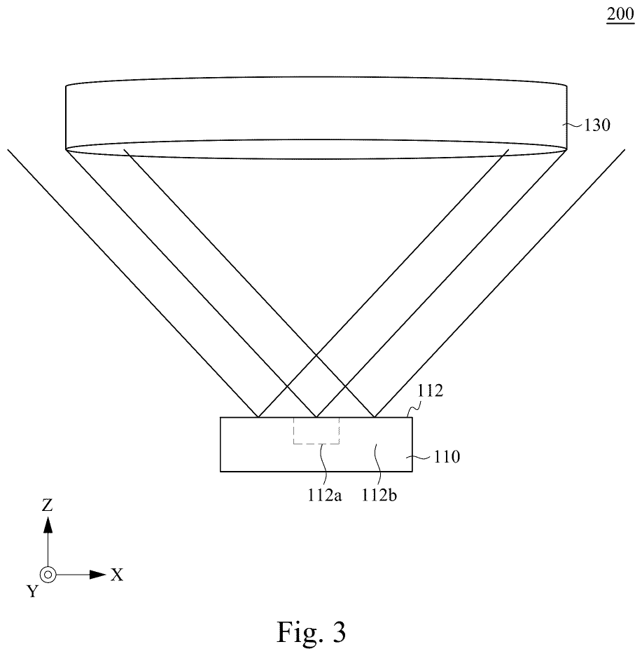

To clearly illustrate the collimating function of the multifocal meta-lens 120, FIG. 2 illustrates the light paths of the meta-optical device 100 in X-Z plane, and FIG. 3 illustrates the light paths of an optical device 200 without the multifocal meta-lens 120 in X-Z plane, according to some embodiments of the present disclosure. In the optical device 200, all of the light beam emitted by a central axis region 112a of the light-emitting surface 112 may be received by the light-receiving element 130, while only a portion of the light beam emitted by an off-axis region 112b outside of the central axis region 112a may be received by the light-receiving element 130. In other words, the effective light-emitting area of the light-emitting element 110 for the optical device 200 equals to the area of the central axis region 112a on the light-emitting surface 112, while the light beam emitted by the off-axis region 112b cannot be effectively coupled to the light-receiving element 130.

In the meta-optical device 100, the multifocal meta-lens 120 has the focus regions 122 projected onto the light-emitting surface 112 of the light-emitting element 110. When the light beam is emitted by the light-emitting surface 112 in the focus region 122, the light beam refracted by the multifocal meta-lens 120 may have a reduced divergence angle, so that the luminous flux from the focus region 122 may be totally received by the light-receiving element 130. When the light beam is emitted by the light-emitting surface 112 outside of the focus region 122 (or referred to as the off-axis region), the convergence of the light beam may be too low for the light beam to be totally received by the light-receiving element 130. In other words, the focus regions 122 may all be considered as the effective optical regions for the meta-optical device 100, and the effective light-emitting area of the one light-emitting element 110 equals to a sum of the areas of the focus regions 122 covering the light-emitting surface 112. Compared to the optical device 200, the meta-optical device 100 having larger effective light-emitting area may couple the light source more effectively. Therefore, the meta-optical device 100 may be suitable for optical devices, such as opto-mechanical system, augmented reality (AR) wearable device, or virtual reality (VR) wearable device.

Referring back to FIG. 1, the focus regions 122 of the multifocal meta-lens 120 projected onto the light-emitting surface 112 have appropriate dimensions, which may significantly increase the effective light-emitting area of the light-emitting element 110. Specifically, a focus region 122 may be a circle region with a diameter φ on the light-emitting surface 112. In a direction perpendicular to the light-emitting surface 112 (for example, Z-axis direction in FIG. 1), the multifocal meta-lens 120 is distanced from the light-emitting surface 112 by a distance d. When the light-receiving element 130 has an acceptance angle θ, the diameter φ of the focus region 122 may be smaller than or equal to 2 times product of the distance d and the tangent of the acceptance angle θ. As a result, the multiple focus regions 122 may continuously cover the light-emitting surface 112 to increase the effective light-emitting area of the light-emitting element 110. In other words, the diameter φ of the focus region 122, the distance d between the multifocal meta-lens 120 and the light-emitting surface 112, and the acceptance angle θ of the light-receiving element 130 meet: φ≤(2×d×tan(θ)). In this case, the focus region 122 may cover 30% to 100% of the area of the light-emitting surface 112 and significantly increase the light transmission efficiency of the meta-optical device 100. If φ>(2×d×tan(θ)), the focus regions 122 may become separated segments while increase the off-axis regions between the focus regions 122, which reduces the effective light-emitting area of the light-emitting element 110.

In some embodiments, the light-receiving element 130 may be an optical fiber or silicon photonic having a large acceptance angle θ, which increases the area of the focus regions 122 on the light-emitting surface 112. For example, the light-receiving element 130 may be an optical fiber or silicon photonic having a numerical aperture (NA), where the acceptance angle θ and the numerical aperture (NA) meet: θ=sin−1(NA). As the light-receiving element 130 has high numerical aperture, the diameter of the focus region 122 may be large enough to fully cover the light-emitting surface 112 to increase the effective light-emitting area of the light-emitting element 110.

In some embodiments, the dimension of the cross-sectional areas of the light-emitting element 110, the multifocal meta-lens 120, and the light-receiving element 130 may be similar or gradually increased in a direction from the light-emitting element 110 to the light-receiving element 130, which increases the light-receiving efficiency of the light-receiving element 130. For example, the light-emitting surface 112 of the light-emitting element 110 has a maximum aperture L in X-axis direction, the multifocal meta-lens 120 has an aperture W, in X-axis direction, and the light incident surface 132 of the light-receiving element 130 has a radius R in X-axis direction. The maximum aperture L is smaller than or equal to the aperture W, while the aperture W is smaller than or equal to 2 times radius R. This configuration of the dimensions may maximize the receiving efficiency of the light-receiving element 130 for the light from the light-emitting element 110.

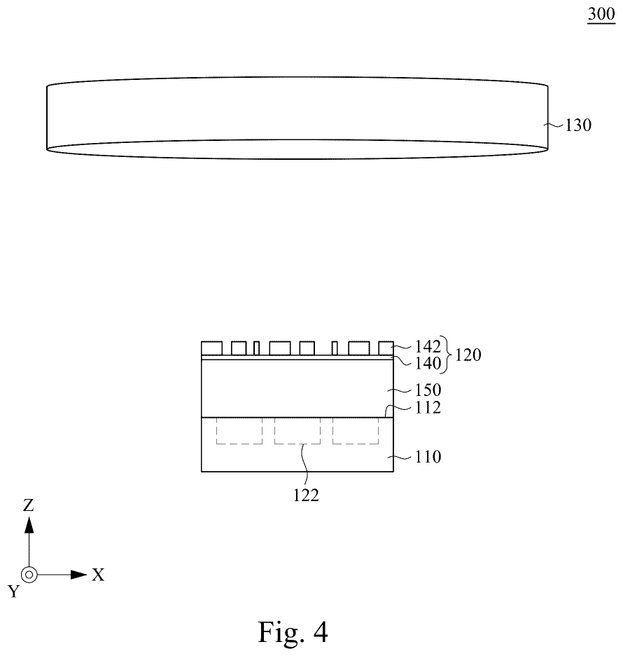

In some embodiments, the multifocal meta-lens 120 may include multiple nanostructures, where the phase of the nanostructures changes the light paths and reduces the divergence angle. For example, FIG. 4 illustrates a schematic side view of a meta-optical device 300 in X-Z plane, according to some embodiments of the present disclosure. The meta-optical device 300 is similar to the meta-optical device 100 in FIG. 1, where the multifocal meta-lens 120 of the meta-optical device 300 includes a lens substrate 140 and multiple nanostructures 142 on the lens substrate 140. The phase combination of the nanostructures 142 results in the multiple focus regions 122 of the multifocal meta-lens 120 projected onto the light-emitting surface 112, thereby changing the light paths from the light-emitting surface 112 and reducing the divergence angle.

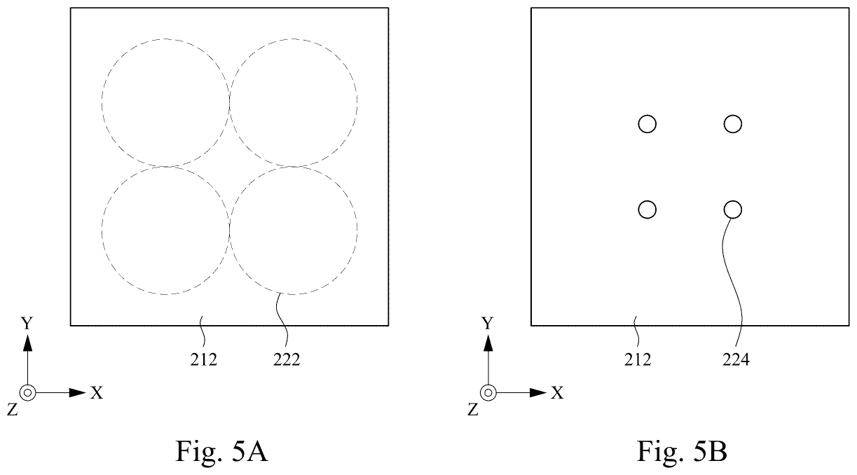

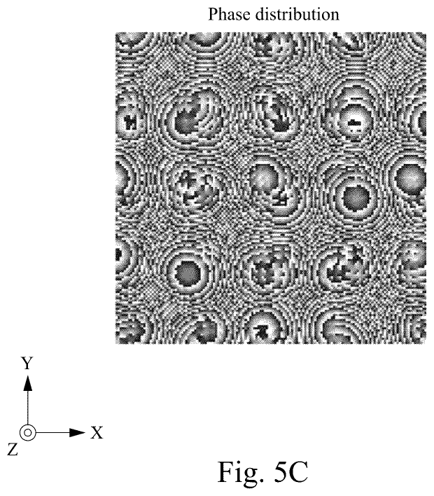

According to some embodiments of the present disclosure, FIG. 5A illustrates a distribution of the focus regions 222 of a multifocal meta-lens projected onto a light-emitting surface 212; FIG. 5B illustrates a distribution of the collimating focal points 224 of the focus regions 222 on the light-emitting surface 212; and FIG. 5C illustrates a phase distribution of the nanostructures of the multifocal meta-lens resulting in the focus regions 222. FIGS. 5A-5C are taken from X-Y plane of the meta-optical device. The focus regions 222 in FIG. 5A are all positioned in the range of the light-emitting surface 212, where the focus regions 222 are connected by boundaries of the focus regions without being overlapped. The respective center point of each focus region 222 in FIG. 5A acts as one of the collimating focal points 224 in FIG. 5B, where each collimating focal point 224 of the focus region 222 is outside of the other focus regions 222. When the multifocal meta-lens has the collimating focal points 224 shown in FIG. 5B and the focal depths corresponding to the focus regions 222 in FIG. 5A, a phase combination of the nanostructures of the multifocal meta-lens may be represented by the phase distribution in FIG. 5C.

When the multifocal meta-lens is predetermined to have the focus regions 222 shown in FIG. 5A, a group of the nanostructures may be formed in the multifocal meta-lens according to the distribution of the collimating focal points 224 shown in FIG. 5B and the corresponding focal depths, where the group of the nanostructures shows the phase distribution shown in FIG. 5C. On the other hand, when the combination of the nanostructures of the multifocal meta-lens has the phase distribution shown in FIG. 5C, the multifocal meta-lens would have the collimating focal points 224 shown in FIG. 5B and the corresponding focal depths to form the focus regions 222 shown in FIG. 5A. According to the above-mentioned, the distribution of the collimating focal points 224 shown in FIG. 5B corresponds to the phase distribution of the nanostructures shown in FIG. 5C.

In some embodiments, a phase distribution of the nanostructures and a collimating focal point distribution of the focus regions on the light-emitting surface may be related by Fourier transform or inverse Fourier transform. For example, when the multifocal meta-lens is predetermined to be fabricated with the focus regions 222 shown in FIG. 5A, the distribution of the collimating focal points 224 in FIG. 5B may be Fourier transformed once or more times into the phase distribution of the nanostructures in FIG. 5C. On the other hand, when the nanostructures of the multifocal meta-lens provide the phase distribution in FIG. 5C, the phase distribution in FIG. 5C may be inverse Fourier transformed once or more times into the distribution of the collimating focal points 224 in FIG. 5B.

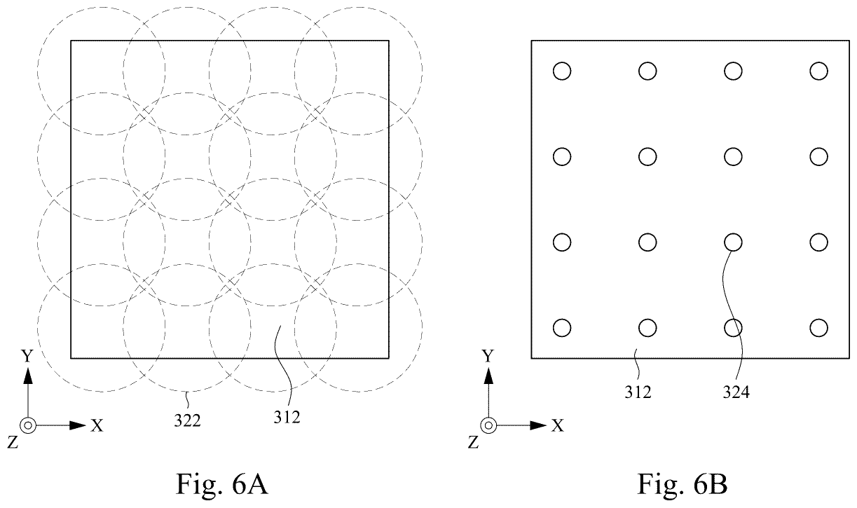

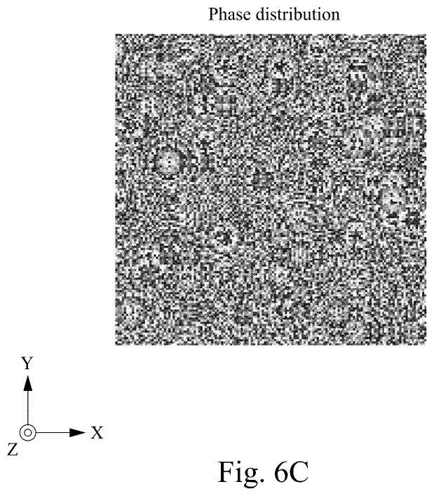

According to some other embodiments of the present disclosure, FIG. 6A illustrates a distribution of the focus regions 322 of a multifocal meta-lens projected onto a light-emitting surface 312; FIG. 6B illustrates a distribution of the collimating focal points 324 of the focus regions 322 on the light-emitting surface 312; and FIG. 6C illustrates a phase distribution of the nanostructures of the multifocal meta-lens resulting in the focus regions 322. The focus regions 322 shown in FIG. 6A collectively cover the light-emitting surface 312, where a portion of the focus regions 322 at the edge of the light-emitting surface 312 is outside of the light-emitting surface 312. The focus regions 322 are partially overlapped, so that the light-emitting surface 312 is fully covered by the focus regions 322. The respective center point of each focus region 322 in FIG. 6A acts as one of the collimating focal points 324 in FIG. 6B, where each collimating focal point 324 of the focus region 322 is outside of the other focus regions 322. The phase distribution of the nanostructures in FIG. 6C and the distribution of the collimating focal points 324 on the light-emitting surface 312 in FIG. 6B are related by Fourier transform or inverse Fourier transform.

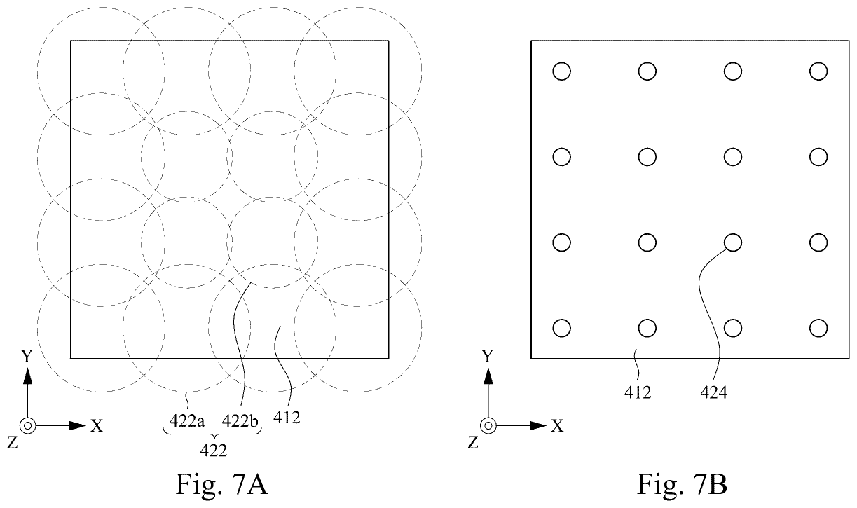

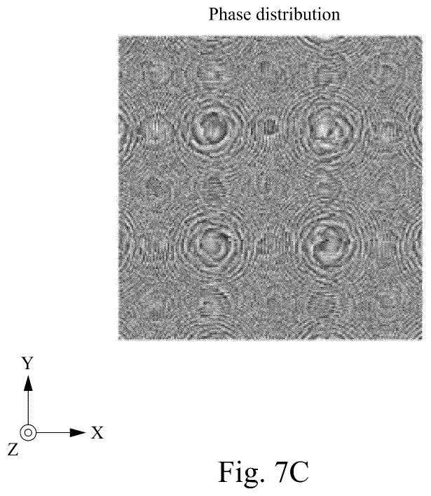

According to some other embodiments of the present disclosure, FIG. 7A illustrates a distribution of the focus regions 422 of the multifocal meta-lens projected onto a light-emitting surface 412; FIG. 7B illustrates a distribution of the collimating focal points 424 of the focus region 422 on the light-emitting surface 412; and FIG. 7C illustrates a phase distribution of the nanostructures of the multifocal meta-lens resulting in the focus regions 422. The distribution of the focus regions 422 in FIG. 7A is similar to the distribution of the focus region 322 focus regions 322 in FIG. 6A, but the focal depth of the center region of the light-emitting surface 412 is deeper than the focal depth of the periphery region of the light-emitting surface 412. As a result, the diameter of the focus regions 422b at the center region of the light-emitting surface 412 is smaller than the diameter of the focus regions 422a at the periphery region of the light-emitting surface 412. The respective center point of each focus region 422 in FIG. 7A acts as one of the collimating focal points 424 in FIG. 7B, where each collimating focal point 424 of the focus region 422 is outside of the other focus regions 422. The phase distribution of the nanostructures in FIG. 7C and the distribution of the collimating focal points 424 on the light-emitting surface 412 in FIG. 7B are related by Fourier transform or inverse Fourier transform. Although the distribution of the collimating focal points 424 in FIG. 7B is similar to the distribution of the collimating focal points 324 in FIG. 6B, the focal depths corresponding to the focus regions 422 in FIG. 7A are different from the focal depths corresponding to the focus regions 322 in FIG. 6A. Therefore, the transform formula for FIG. 6B and FIG. 6C may be different from the transform formula for FIG. 7B and FIG. 7C.

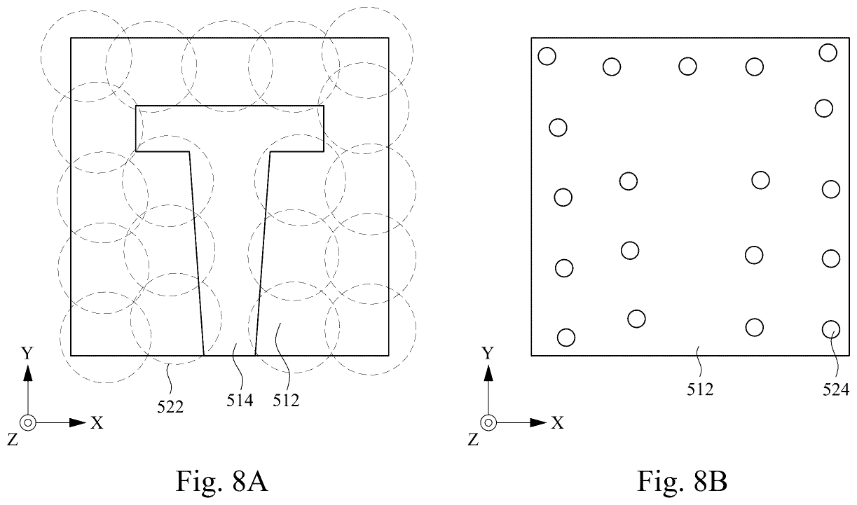

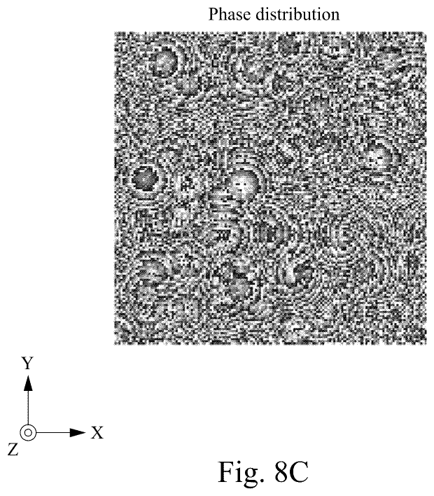

According to some other embodiments of the present disclosure, FIG. 8A illustrates a distribution of the focus regions 522 of a multifocal meta-lens projected onto a light-emitting surface 512; FIG. 8B illustrates a distribution of the collimating focal points 524 of the focus regions 522 on the light-emitting surface 512; and FIG. 8C illustrates a phase distribution of the nanostructures of the multifocal meta-lens resulting in the focus regions 522. The light-emitting surface 512 includes a non-emission region 514, for example, an electrode that may be formed of an opaque material. The focus regions 522 in FIG. 8A surround the non-emission region 514 along the edge of the non-emission region 514 while the focus regions 522 are partially overlapped, so that the light-emitting region of the light-emitting surface 512 may be fully covered by the focus regions 522. The focus regions 522 in FIG. 8A have the corresponding collimating focal points 524 in FIG. 8B, where each collimating focal point 524 of the focus region 522 is outside of the other focus regions 522. The phase distribution of the nanostructures in FIG. 8C and the distribution of the collimating focal points 524 on the light-emitting surface 512 in FIG. 8B are related by Fourier transform or inverse Fourier transform.

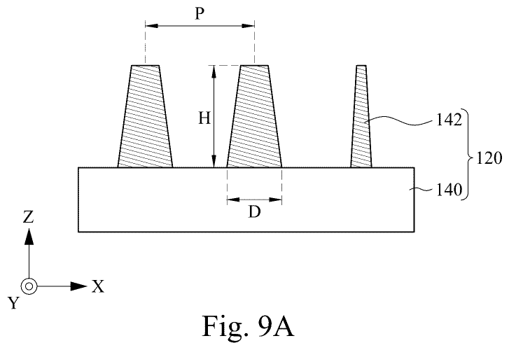

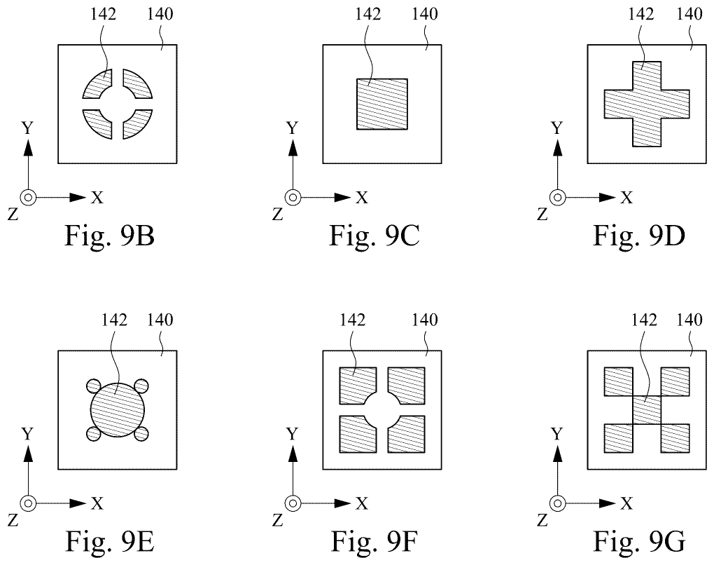

In some embodiments, the nanostructures of the multifocal meta-lens may having the dimensions or patterns according to the characteristics of the light-emitting element or the light-receiving element, so that the combination of the nanostructure phases may result in the focus regions of the multifocal meta-lens. According to some embodiments of the present disclosure, FIG. 9A illustrates a cross-section schematic view of a multifocal meta-lens 120 in X-Z plane, where the multifocal meta-lens 120 includes a lens substrate 140 and multiple nanostructures 142 on the top surface of the lens substrate 140. As the light-emitting element provides an emission wavelength A, the nanostructure 142 separated from each other may have a pitch P smaller than 0.7 times the emission wavelength A. The nanostructures 142 may have a dimension D on the lens substrate 140 parallel to the direction of the pitch P, and the dimension D may be between 0.1 times pitch P and 0.95 times pitch P. For example, when the nanostructures 142 have a cylinder shape, the dimension D of the nanostructures 142 may be the diameter in the cross-sectional of the cylinder on the lens substrate 140. The nanostructures 142 may have a consistent dimension in the direction perpendicular to the top surface of the lens substrate 140, or the nanostructures 142 may have a gradient dimension as shown in FIG. 9A. Additionally, as the lens substrate 140 has a refractive index n, a height H of the nanostructures 142 in the direction perpendicular to the top surface of the lens substrate 140 may be larger than a quotient of emission wavelength λ by (refractive index n minus 1), i.e.,

$$H > \frac{λ}{n - 1} .$$

In some embodiments which the lens substrate 140 is closer to the light-emitting element, the refractive index of the nanostructures 142 may be higher than the refractive index of the lens substrate 140 to collimate the light beam from the light-emitting element more easily by the multifocal meta-lens 120.

According to some embodiments of the present disclosure, FIGS. 9B-9G illustrate partial cross-section schematic views of multifocal meta-lenses in X-Y plane. FIGS. 9B-9G illustrate one of the nanostructures 142 on the lens substrate 140, respectively, and the nanostructure 142 in each figure has different cross-section shape. The nanostructures of the multifocal meta-lens may have solid, hollow, or segmental of the geometry cross-sectional shapes according to the phase distribution requirement for the multifocal meta-lens. For example, FIG. 9B illustrates a hollow segmental circle cross-section, FIG. 9C illustrates a square cross-section, FIG. 9D illustrates a cross-shaped cross-section, FIG. 9E illustrates a multi-circle cross-section, FIG. 9F illustrates a hollow segmental square cross-section, and FIG. 9G illustrates a multi-square cross-section. The nanostructures of one multifocal meta-lens may have different cross-sectional shapes or dimensions from each other.

Referring back to FIG. 4, the multifocal meta-lens 120 of the meta-optical device 300 includes the lens substrate 140 and the nanostructures 142 on the top surface of the lens substrate 140. The lens substrate 140 is closer to the light-emitting element 110, and the nanostructures 142 protrude toward the direction away from the light-emitting element 110. The meta-optical device 300 may also include a light guide layer 150 between the multifocal meta-lens 120 and the light-emitting element 110 to guide the light beam from the light-emitting element 110 to the multifocal meta-lens 120. For example, the light guide layer 150 may be formed of glass, oxide, light guide material, or other transparent materials. The light guide layer 150 may be used to adjust the distance between the multifocal meta-lens 120 and the light-emitting element 110, so that the focus regions 122 of the multifocal meta-lens 120 projected onto the light-emitting surface 112 have appropriate dimensions. In some embodiments, the light guide layer 150 may be directly formed on the light-emitting element 110, and the multifocal meta-lens 120 may be directly formed on the light guide layer 150. As a result, the light guide layer 150 directly contacts the light-emitting surface 112 of the light-emitting element 110 and the lens substrate 140 of the multifocal meta-lens 120. In such embodiments, the thickness of the light guide layer 150 in the direction perpendicular to the light-emitting surface 112 may be the separated distance between the multifocal meta-lens 120 and the light-emitting element 110, for example, the distance d in FIG. 1.

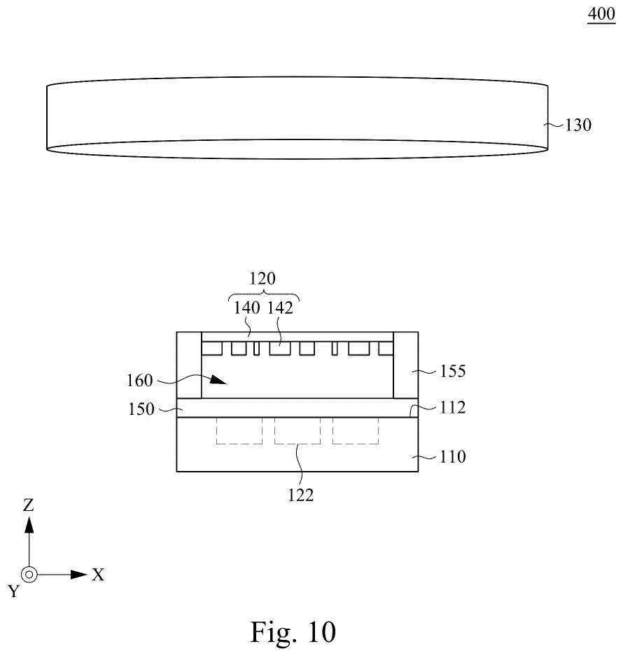

According to some other embodiments of the present disclosure, FIG. 10 illustrates a schematic side view of a meta-optical device 400 in X-Z plane. The meta-optical device 400 is similar to the meta-optical device 300 in FIG. 4, but the multifocal meta-lens 120 of the meta-optical device 400 includes a lens substrate 140 and nanostructures 142 below the bottom surface of the lens substrate 140. The nanostructures 142 are closer to the light-emitting element 110, and the nanostructures 142 protrude toward the light-emitting element 110. The meta-optical device 400 may also include a light guide layer 150 between the multifocal meta-lens 120 and the light-emitting element 110 and a frame 155 around the multifocal meta-lens 120, where the multifocal meta-lens 120 is aligned and attached to the light guide layer 150 by the frame 155. Therefore, the frame 155 connects the lens substrate 140 to the light guide layer 150, and the frame 155 separates the nanostructures 142 from the light guide layer 150. In some embodiments, the meta-optical device 400 may also include a medium layer 160 between the multifocal meta-lens 120 and the light guide layer 150, where the medium layer 160 is surrounded by the frame 155. The medium layer 160 fills the gaps between the nanostructures 142, and the medium layer 160 separates the nanostructures 142 from the light guide layer 150. For example, the medium layer 160 may be vacuum or filled with gas or liquid.

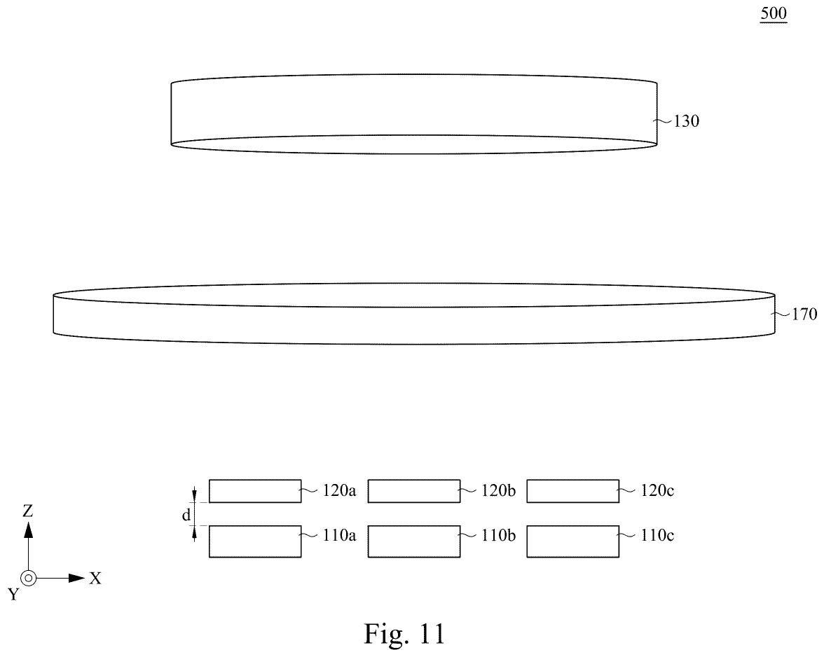

According to some embodiments of the present disclosure, FIG. 11 illustrates a schematic side view of a meta-optical device 500 in X-Z plane. The meta-optical device 500 is similar to the meta-optical device 300 in FIG. 4, but the meta-optical device 500 includes different number of the light-emitting element 110 and an additional lens. Specifically, the meta-optical device 500 includes a light-emitting element 110a, a multifocal meta-lens 120a above the light-emitting element 110a, a light-emitting element 110b, a multifocal meta-lens 120b above the light-emitting element 110b, a light-emitting element 110c, and a multifocal meta-lens 120c above the light-emitting element 110c. The light-emitting element 110a, the light-emitting element 110b, and the light-emitting element 110c are adjacently arranged along X-axis direction to for a light-emitting element array, and the multifocal meta-lenses 120a-120c may have a respective nanostructure combination corresponding to each of the light-emitting elements 110a-110c to increase the effective light-emitting area of the light-emitting elements 110a-110c. In the direction, such as Z-axis direction in FIG. 11, perpendicular to the light-emitting surfaces of the light-emitting elements 110a-110c, the multifocal meta-lenses 120-120c are separated from the light-emitting surface of the light-emitting elements 110a-110c by a distance d, respectively. The meta-optical device 500 also includes a light-receiving element 130 above the multifocal meta-lenses 120a-120c and a meta-lens 170 between the multifocal meta-lenses 120a-120c and the light-receiving element 130. The light beams emitted by the light-emitting elements 110a-110c pass through the corresponding one of the multifocal meta-lenses 120a-120c and collectively pass through meta-lens 170 to reach the light-receiving element 130. The meta-lens 170 may further adjust the direction or phase of the light beams to focus the light beams from the light-emitting elements 110a-110c onto the same light-receiving element 130. In some embodiments which the light-emitting surfaces of the light-emitting elements 110a-110c are in a same horizontal plane (i.e., X-Y plane), the meta-lens 170 may be a single focal meta-lens.

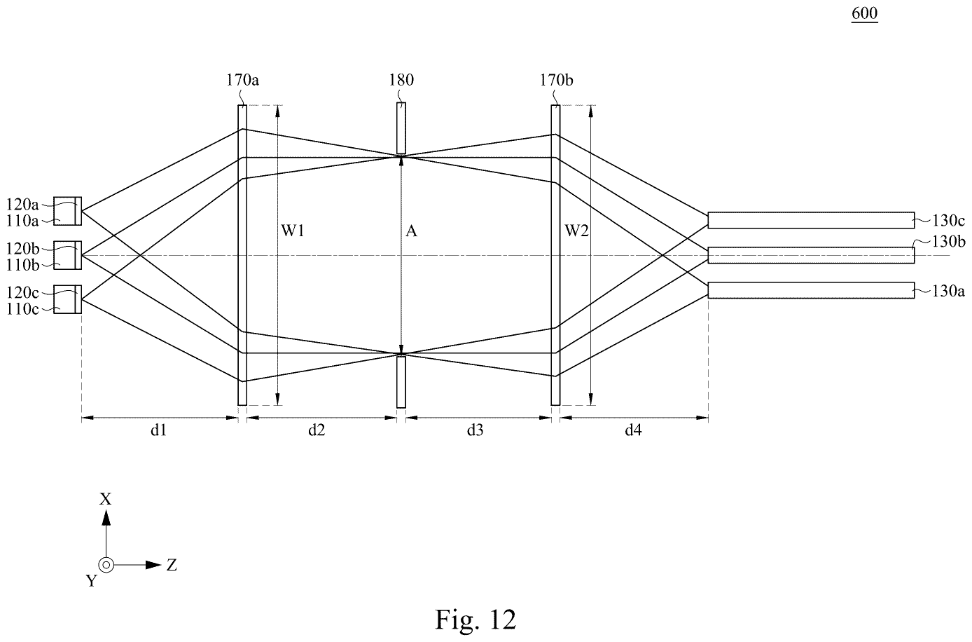

According to some embodiments of the present disclosure, FIG. 12 illustrates a schematic side view of a meta-optical device 600 in X-Z plane. The meta-optical device 600 is similar to the meta-optical device 500 in FIG. 11, but the meta-optical device 600 includes different numbers of the light-receiving elements 130 and the meta-lens 170. Specifically, the meta-optical device 600 includes light-emitting elements 110a-110c arranged along X-axis direction and multifocal meta-lenses 120a-120c corresponding to each of the light-emitting elements to increase the respective effective light-emitting area of the light-emitting elements 110a-110c. After the directions of the light beams through the multifocal meta-lenses 120a-120c are adjusted twice by a meta-lens 170a and a meta-lens 170b, the light beams may be received by the light-receiving elements 130a-130c, respectively. In other words, the meta-lens 170a and the meta-lens 170b may provide the one-to-one relationship between the light-emitting elements 110a-110c and the light-receiving elements 130a-130c.

In some embodiments, the meta-optical device 600 may also include a shielding ring 180 between the meta-lens 170a and the meta-lens 170b, where the light beams through the meta-lens 170a will pass through the hole of the shielding ring 180 before passing through the meta-lens 170b. The shielding ring 180 may reduce the crosstalk between the light beams emitted by the light-emitting elements 110a-110c, which may increase the receiving accuracy of the light beams from the light-emitting elements 110a-110c to the light-receiving elements 130a-130c. Taking FIG. 12 for an example, after the directions of the light beams through the multifocal meta-lens 120a and the multifocal meta-lens 120c are adjusted by the meta-lens 170a, the light beams become tilted with respect to Z-axis direction. When the tilted light beams reach the shielding ring 180, the shielding ring 180 may block the light portion with large tilt angle. As a result, the light beam through the multifocal meta-lens 120a and the meta-lens 170a will only be focused on the light-receiving element 130a by the meta-lens 170b, and the light beam through the multifocal meta-lens 120c and the meta-lens 170a will only be focused on the light-receiving element 130c by the meta-lens 170b. In Z-axis direction, a distance d1 between the meta-lens 170a and the multifocal meta-lenses, such as the multifocal meta-lenses 120a-120c and a distance d2 between the meta-lens 170a and the shielding ring 180 may equal to the focal length of the meta-lens 170a, and a distance d3 between the meta-lens 170a and shielding ring 180 and a distance d4 between the meta-lens 170b and the light-receiving elements, such as the light-receiving elements 130a-130c, may equal to the focal length of the meta-lens 170b to improve the coupling efficiency of the meta-optical device 600. Additionally, an aperture A of the shielding ring 180 may be smaller than an aperture W1 of the meta-lens 170a and an aperture W2 of the meta-lens 170b, thereby preventing the light beams from crosstalk. For example, the aperture A of the shielding ring 180 may meet: A=2×sin(beam angle of the multifocal meta-lens)×(focal length of the meta-lens 170a), or the aperture A of the shielding ring 180 may meet: A=2×sin(acceptance angle of the light-receiving element)×(focal length of the meta-lens 170b).

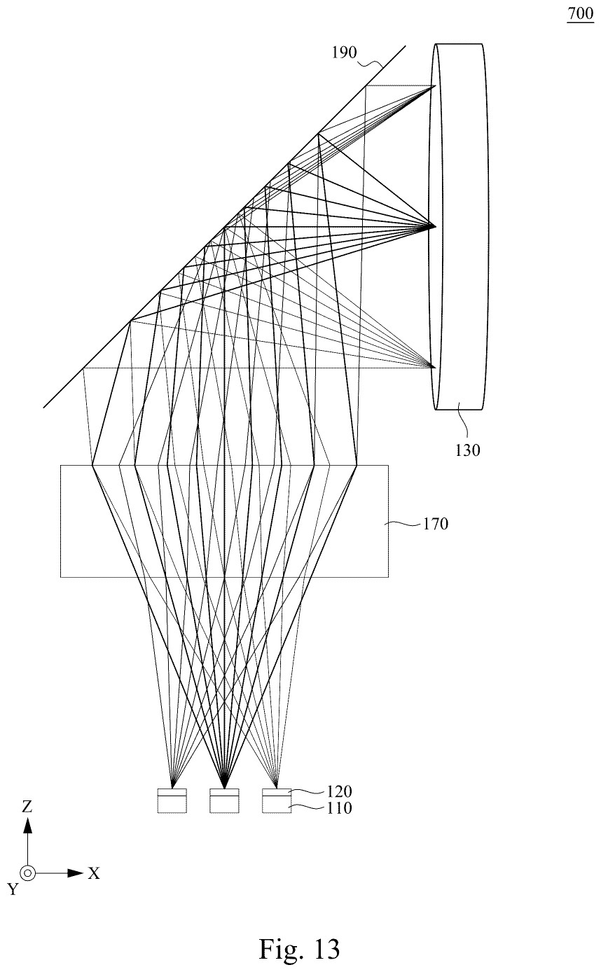

According to some embodiments of the present disclosure, FIG. 13 illustrates a schematic side view of a meta-optical device 700 in X-Z plane. The meta-optical device 700 is similar to the meta-optical device 500 in FIG. 11, but the meta-optical device 700 includes additional lens to increase the assembly flexibility of the optics. Specifically, the meta-optical device 700 includes a plurality of light-emitting elements 110 arranged along X-axis direction and a plurality of multifocal meta-lenses 120 corresponding to the light-emitting elements 110 to increase the respective effective light-emitting area of the light-emitting elements 110. After the light beams emitted by the light-emitting elements 110 collectively pass through the meta-lens 170 above the multifocal meta-lenses 120, the directions of the light beams are changed by passing through the folding mirror 190 above the meta-lens 170. Therefore, the light beams passing through the multifocal meta-lenses 120 may be effectively received by the light-receiving element 130, even if a direction (for example, Z-axis direction in FIG. 13) of an extended line from one of the multifocal meta-lenses 120 to a center point of the folding mirror 190 is different from a direction (for example, X-axis direction in FIG. 13) of an extended line from the light-receiving element 130 to the center point of the folding mirror 190.

According to the above-mentioned embodiments, the meta-optical device of the present disclosure includes the multifocal meta-lens, the light-emitting element, and the light-receiving element, where the light-emitting element and the light-receiving element are one opposite sides of the multifocal meta-lens. The multifocal meta-lens has the focus regions projected onto the light-emitting surface of the light-emitting element, and the diameter (φ) of the focus regions is smaller than or equal to 2 times product of the distance (d) between the multifocal meta-lens and the light-emitting element and the tangent of the acceptance angle (θ) of the light-emitting element. The focus regions may continuously cover the light-emitting surface to increase the effective light-emitting area of the light-emitting element, thereby increasing the coupling efficiency of the meta-optical device. The multifocal meta-lens may include the nanostructures having different phases, so that the position and dimension of the focus regions on the light-emitting surface may be modified by adjusting the phase distribution of the nanostructures.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A meta-optical device, comprising:
a light-emitting element having a light-emitting surface;
a multifocal meta-lens above the light-emitting surface of the light-emitting element, wherein the multifocal meta-lens is distanced from the light-emitting surface by a distance (d) in a direction perpendicular to the light-emitting surface, and the multifocal meta-lens has a plurality of focus regions projected onto the light-emitting surface; and
a light-receiving element on a side of the multifocal meta-lens opposite to the light-emitting element, wherein a diameter (φ) of each of the focus regions on the light-emitting surface, the distance (d), and an acceptance angle (θ) of the light-receiving element meet: φ≤(2×d×tan(θ)).

2. The meta-optical device of claim 1, wherein the multifocal meta-lens comprises nanostructures on a top surface of a lens substrate or below a bottom surface of the lens substrate, and a phase distribution of the nanostructures and a collimating focal point distribution of the focus regions on the light-emitting surface are related by Fourier transform or inverse Fourier transform.

3. The meta-optical device of claim 1, wherein the multifocal meta-lens comprises nanostructures on a top surface of a lens substrate or below a bottom surface of the lens substrate, a pitch of the nanostructures is smaller than 0.7 times a emission wavelength (A) of the light-emitting element, and a dimension of the nanostructures on the lens substrate in a direction parallel to the pitch is between 0.1 times the pitch and 0.95 times the pitch.

4. The meta-optical device of claim 3, wherein a height (H) of the nanostructures in a direction perpendicular to the top surface of the lens substrate, the emission wavelength (λ), and a refractive index (n) of the lens substrate meet:
$$H > \frac{λ}{n - 1} .$$

5. The meta-optical device of claim 3, wherein a refractive index of the nanostructures is higher than a refractive index of the lens substrate.

6. The meta-optical device of claim 3, wherein the nanostructures have different cross-section shapes in a plane parallel to the top surface of the lens substrate.

7. The meta-optical device of claim 1, wherein the focus regions cover 30% to 100% of an area of the light-emitting surface.

8. The meta-optical device of claim 1, wherein a collimating focal point of each of the focus regions is outside of others of the focus regions.

9. The meta-optical device of claim 1, wherein the focus regions are connected by boundaries of the focus regions, or wherein the focus regions are partially overlapped.

10. The meta-optical device of claim 1, wherein a portion of the focus regions is outside of the light-emitting surface.

11. The meta-optical device of claim 1, wherein the focus regions comprise a first focus region having a first diameter and a second focus region having a second diameter, the first diameter is smaller than the second diameter, and a focal depth of the first focus region is deeper than a focal depth of the second focus region.

12. The meta-optical device of claim 1, wherein the light-emitting surface comprises a non-emission region, the focus regions surround the non-emission region along an edge of the non-emission region.

13. The meta-optical device of claim 1, wherein a maximum aperture of the light-emitting surface of the light-emitting element is smaller than or equal to an aperture of the multifocal meta-lens, and the aperture of the multifocal meta-lens is smaller than or equal to a diameter of a light incident surface of the light-receiving element.

14. The meta-optical device of claim 1, further comprising:
a light guide layer between the multifocal meta-lens and the light-emitting element, wherein the light guide layer directly contacts the light-emitting surface of the light-emitting element and the multifocal meta-lens.

15. The meta-optical device of claim 1, further comprising:
a light guide layer between the multifocal meta-lens and the light-emitting element;
a frame around the multifocal meta-lens, wherein the frame connects the multifocal meta-lens to the light guide layer; and
a medium layer separating the multifocal meta-lens and the light guide layer.

16. The meta-optical device of claim 1, wherein the acceptance angle (θ) of the light-receiving element and a numerical aperture (NA) of the light-receiving element meet: θ=sin⁻¹(NA).

17. The meta-optical device of claim 1, further comprising:
a folding mirror above the multifocal meta-lens, wherein a direction of an extended line from the multifocal meta-lens to a center point of the folding mirror is different from a direction of an extended line from the light-receiving element to the center point of the folding mirror.

18. A meta-optical device, comprising:
a light-emitting element array comprising a plurality of light-emitting elements adjacently arranged, wherein each of the light-emitting elements has a light-emitting surface;
a plurality of multifocal meta-lenses above the light-emitting element array, wherein the multifocal meta-lenses are distanced from the light-emitting elements by a distance (d), and each of the multifocal meta-lenses has a plurality of focus regions projected onto the light-emitting surface of a corresponding one of the light-emitting elements, respectively;
a meta-lens above the multifocal meta-lenses; and
at least one light-receiving element on a side of the meta-lens opposite to the multifocal meta-lenses, wherein a diameter (φ) of each of the focus regions, the distance (d), and an acceptance angle (θ) of the at least one light-receiving element meet: φ≤(2×d×tan(θ)).

19. The meta-optical device of claim 18, wherein the light-emitting elements comprise a first light-emitting element and a second light-emitting element, the at least one light-receiving element comprise a first light-receiving element and a second light-receiving element, and light beams emitted by the first light-emitting element and the second light-emitting element are received by the first light-receiving element and the second light-receiving element, respectively.

20. The meta-optical device of claim 18, wherein the light-emitting surfaces of the light-emitting elements are in a same horizontal plane, and the meta-lens is a single focal meta-lens.
